(19) United States
(12) Patent Application Publication
(10) Pub. No.: US 2020/0119902 A1
(43) Pub. Date: Apr. 16, 2020

(54) PAYLOAD TRANSPORT ON AUDIO BUSES FOR SIMPLE PULSE DIVISION MULTIPLEXED (PDM) DEVICES

(71) Applicant: QUALCOMM Incorporated, San Diego, CA (US)

(72) Inventors: Lior Amarilio, Yokneam (IL); Sharon Graif, Zichron Yaakov (IL); Yiftach Benjamini, Givat Ela (IL)

(21) Appl. No.: 16/538,924

(22) Filed: Aug. 13, 2019

Related U.S. Application Data
(60) Provisional application No. 62/745,527, filed on Oct. 15, 2018.

(51) Int. Cl. H04L 7/033; H04J 99/00; H04L 12/40; G06F 3/16; H04R 3/00

(52) U.S. Cl. CPC H04L 7/0331; H04J 15/00; H04R 3/00; G06F 3/162; H04L 12/40

(57) ABSTRACT

Systems and methods for payload transport for simple pulse division multiplexed (PDM) devices provide for simple PDM devices to have a phase-locked loop (PLL) that operates at a frequency corresponding to an audio rate on an associated audio bus. Additional parameters are defined relative to a starting synchronization event. The parameters inform a simple PDM device from which bit slots to extract data or into which bit slots to write data. In a further exemplary aspect, a low-cost delay-locked loop (DLL) is used to assist the simple PDM device in calculating the designated bit slots.

### PRIORITY CLAIM

The present application claims priority to U.S. Provisional Patent Application Ser. No. 62/745,527 filed on Oct. 15, 2018 and entitled “PAYLOAD TRANSPORT ON AUDIO BUSES FOR SIMPLE PULSE DIVISION MULTIPLEXED (PDM) DEVICES,” the contents of which is incorporated herein by reference in its entirety.

### BACKGROUND

### I. Field of the Disclosure

The technology of the disclosure relates generally to audio buses and particularly to SOUNDWIRE NEXT audio buses, and more particularly to clock management through payload manipulation for simple devices associated with audio buses.

### II. Background

Mobile communication devices have become increasingly common in current society. The prevalence of these mobile communication devices is driven in part by the many functions that are now enabled on such devices. Increased processing capabilities in such devices means that mobile communication devices have evolved from pure communication tools into sophisticated mobile entertainment centers, enabling enhanced user experiences.

The mobile communication devices commonly include at least one microphone and multiple speakers, although many devices may include multiple microphones as well. The microphone(s) and the speakers used in the mobile communication devices typically have analog interfaces which require a dedicated two-wire connection between each pair of devices. Since a mobile communication device is capable of supporting multiple audio devices, a microprocessor or other control device in the mobile communication device may communicate audio data to multiple audio devices over a common communication bus simultaneously.

In this regard, the MIPI® Alliance initially developed the Serial Low-power Inter-chip Media Bus (SLIMbus℠ or SLIMBUS) to handle audio signals within a mobile communication device. The first release was published in October 2005 with v1.01 released on Dec. 3, 2008, and v2.0 released August 2015. In response to industry feedback, MIPI has also developed SoundWire℠ (SOUNDWIRE), a communication protocol for a processor in the mobile communication device (the “master”) to control distribution of digital audio streams between one or more audio devices (the “slave(s)”) via one or more SOUNDWIRE slave data ports. Version 1.1 was released Jun. 27, 2016 and v1.2 released April 2019. The original SOUNDWIRE was limited to relatively short distances (e.g., <50 cm) that might exist within the mobile communication device. In an effort to accommodate greater distances (e.g., such as when a headset is used), MIPI released a revised protocol, originally referred to as SOUNDWIRE-XL. SOUNDWIRE-XL has been renamed SOUNDWIRE NEXT. A new version of the SOUNDWIRE NEXT specification is expected in October 2018, but as of this writing has not been published.

SOUNDWIRE NEXT has proven exceptionally popular and has been adapted for use within the mobile communication device and not just for distances greater than 50 cm. This popularity has caused more devices (e.g., codecs, speakers, and microphones) to be coupled to the bus. Concurrently, system clocks within the mobile terminal have accelerated, and the speed of the SOUNDWIRE NEXT bus has also increased. As of this writing, in some instances, the SOUNDWIRE NEXT bus may operate at speeds approaching 100 megahertz (MHz).

Many devices, including those that may be attached to a SOUNDWIRE NEXT bus, have a clock recovery circuit that includes a phase-locked loop (PLL) to assist in the stabilization of the recovered clock signal. The higher the frequency of the bus clock, the larger and more expensive the PLL is likely to be. In many instances, commercial pressures dictate that microphones and speakers within mobile terminals or within basic headsets are relatively inexpensive. Thus, the pressure to provide high speeds on the SOUNDWIRE NEXT bus competes with the pressures to keep the PLLs relatively simple. This tension illustrates a need for an alternate approach to clock management on SOUNDWIRE NEXT buses.

### SUMMARY OF THE DISCLOSURE

Aspects disclosed in the detailed description include systems and methods for payload transport on audio buses for simple pulse division multiplexed (PDM) devices. In an exemplary aspect, simple PDM devices have a phase-locked loop (PLL) that operates at a frequency corresponding to an audio rate on an associated audio bus. Additional parameters are defined relative to a starting synchronization event. The parameters inform a simple PDM device from which bit slots to extract data or into which bit slots to write data. In a further exemplary aspect, a low-cost delay-locked loop (DLL) is used to assist the simple PDM device in calculating the designated bit slots. By limiting the PLL to a relatively low frequency, cost and space are reduced. Further, a lower frequency clock may provide power savings.

In this regard in one aspect, a method of reading data from an audio bus is disclosed. The method includes using a DLL circuit on an input signal. The method also includes selecting, with a multiplexer, at least one of a plurality of outputs from the DLL circuit to form at least one selecting signal. The method also includes processing the at least one selecting signal to form a control signal. The method also includes operating on a slot in an audio signal on the audio bus based on the control signal.

In another aspect, an audio device is disclosed. The audio device includes a bus interface configured to couple to an audio bus operating at a bus frequency. The audio device also includes a clock configured to operate at an audio rate slower than the bus frequency. The audio device also includes a transceiver coupled to the bus interface configured to send and receive data on the audio bus. The audio device also includes a circuit including a DLL and a multiplexer. The circuit is configured to use the DLL on an input signal from the audio bus. The circuit is also configured to select with the multiplexer, at least one of a plurality of outputs from the DLL to form at least one selecting signal. The circuit is also configured to process the at least one selecting signal to form a control signal. The circuit is also configured to operate on a slot in an audio signal on the audio bus based on the control signal.

In another aspect, a method for controlling payloads in an audio bus is disclosed. The method includes defining a synchronization event (sync event) corresponding to an audio rate. The method also includes defining a sample window interval corresponding to a number of sync events. The method also includes defining an offset relative to an initial sync event. The method also includes inserting data or receiving data at a device at the offset once per sample window interval.

In another aspect, an audio device is disclosed. The audio device includes a bus interface configured to couple to an audio bus operating at a bus frequency. The audio device also includes a clock configured to operate at an audio rate slower than the bus frequency. The audio device also includes a transceiver coupled to the bus interface configured to send and receive data on the audio bus. The audio device also includes a control system. The control system is configured to insert data or receive data at a predefined offset from a sample window interval start using the clock.

### BRIEF DESCRIPTION OF THE FIGURES

FIG. 1 is a block diagram of an exemplary SOUNDWIRE audio system having a multi-drop differential audio bus;

FIG. 2 is a block diagram of a master device that may be associated with the multi-drop differential audio bus of the audio system of FIG. 1;

FIG. 3 is a block diagram of a slave device that may be associated with the multi-drop differential audio bus of the audio system of FIG. 1;

FIG. 4 is a block diagram of an exemplary mixed SOUNDWIRE and SOUNDWIRE NEXT audio system;

FIG. 5A is an initial representation of two rows of a SOUNDWIRE NEXT signal compared to an embedded clock and illustrating a synchronization event in each row;

FIG. 5B is a simplified representation of four rows of a SOUNDWIRE NEXT signal with synchronization events beginning each row;

FIG. 6A is a first simplified representation of five rows of a SOUNDWIRE NEXT signal using the payload transport mechanisms of the present disclosure;

FIG. 6B is a second simplified representation of five rows of a SOUNDWIRE next signal using the payload transport mechanisms of the present disclosure with grouped bits;

FIG. 7 is a simplified block diagram of a delay-locked loop (DLL) that may be used to isolate a particular bit slot for use with the payload transport mechanisms of the present disclosure;

FIGS. 8A-8C provide simplified representations of different channels using the payload transport mechanisms of the present disclosure where the channels are in different rows;

FIG. 8D provides a simplified representation of a master extracting the channels introduced in FIGS. 8A-8C;

FIGS. 9A-9C provide simplified representations of different channels using the payload transport mechanisms of the present disclosure where the channels are in a single row;

FIG. 9D provides a simplified representation of a master extracting the channels introduced in FIGS. 9A-9C;

FIG. 10A is a flowchart of a process operating according to the payload transport mechanisms of the present disclosure;

FIG. 10B is a flowchart of the processes used by the DLL of FIG. 7;

FIG. 11A is a system-level block diagram of an exemplary mobile terminal that can include the audio system of FIG. 1 or 4;

FIG. 11B is a system-level block diagram of an alternate exemplary mobile terminal that can include the audio system of FIG. 1 or 4; and

FIG. 11C is a system-level block diagram of another alternate exemplary mobile terminal that can include the audio system of FIG. 1 or 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for payload transport on audio buses for simple pulse division multiplexed (PDM) devices. In an exemplary aspect, simple PDM devices have a phase-locked loop (PLL) that operates at a frequency corresponding to an audio rate on an associated audio bus. Additional parameters are defined relative to a starting synchronization event. The parameters inform a simple PDM device from which bit slots to extract data or into which bit slots to write data. In a further exemplary aspect, a low-cost delay-locked loop (DLL) is used to assist the simple PDM device in calculating the designated bit slots. By limiting the PLL to a relatively low frequency, cost and space are reduced. Further, a lower frequency clock may provide power savings

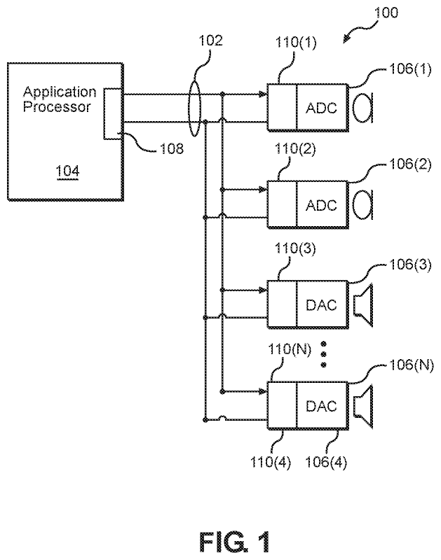

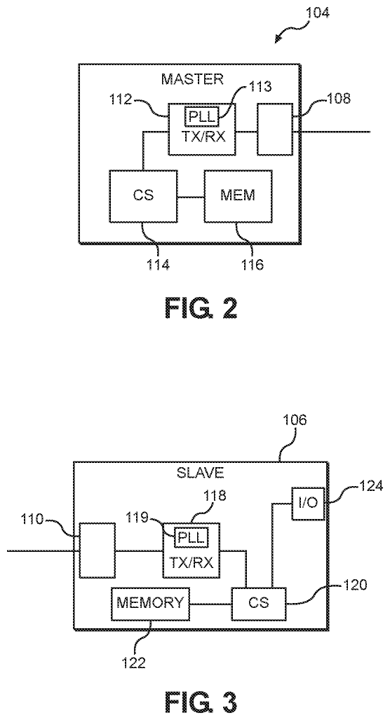

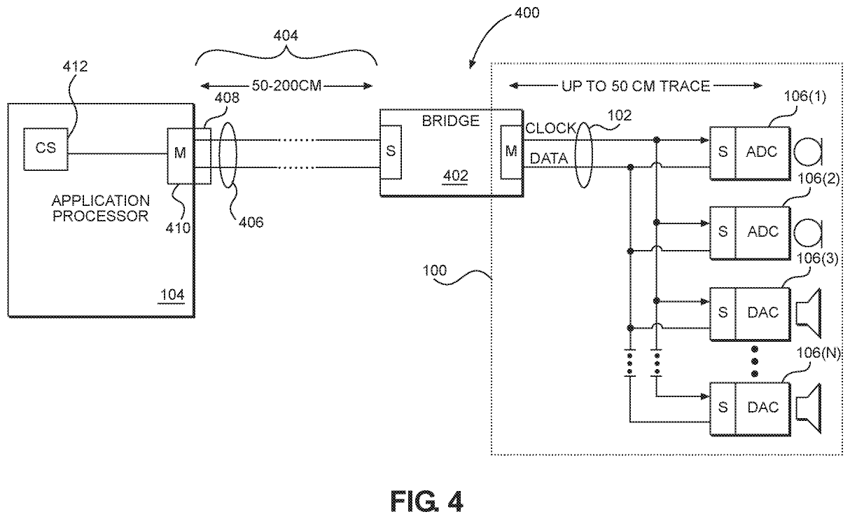

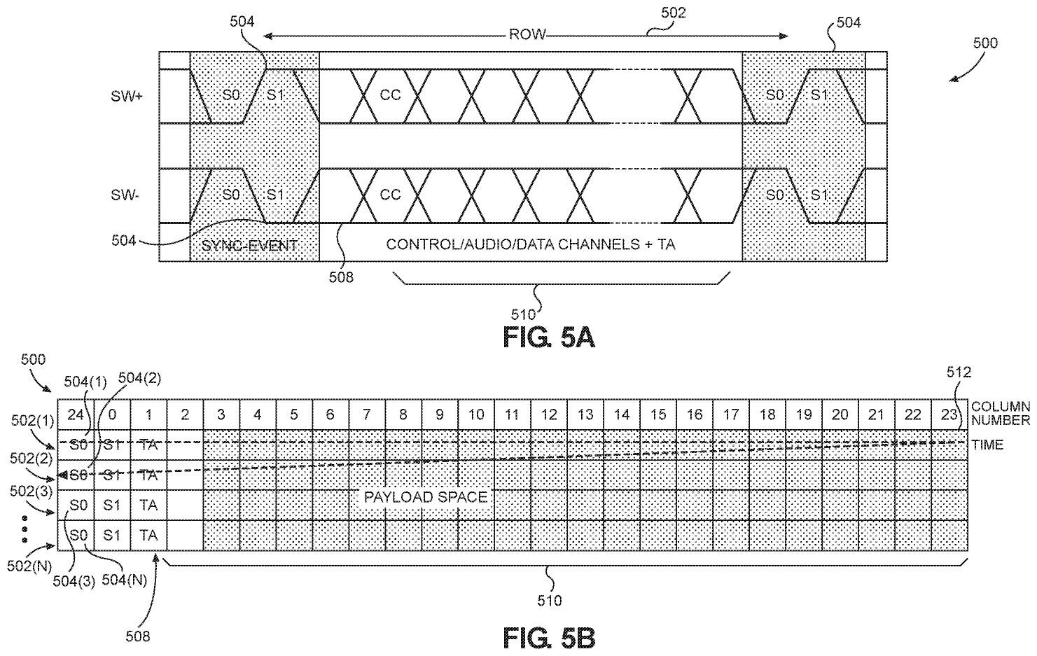

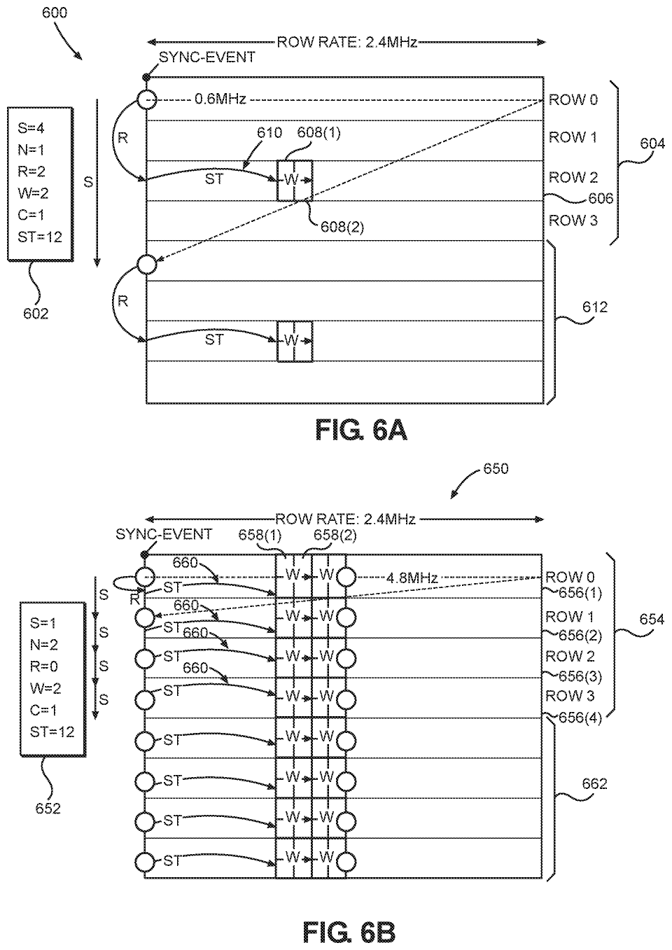

Exemplary aspects of the present disclosure are well-suited for use in SOUNDWIRE NEXT audio systems. However, to provide context for a SOUNDWIRE NEXT audio system, a variety of audio systems are discussed. In this regard, a SOUNDWIRE audio system is discussed with reference to FIG. 1 while master and slave devices are discussed with reference to FIGS. 2 and 3, respectively. A mixed SOUNDWIRE/SOUNDWIRE NEXT audio system is discussed with reference to FIG. 4. The audio sinks and audio sources of FIGS. 2 and 3 may include exemplary aspects of the present disclosure, and thus, the audio systems of FIGS. 1 and 4 may include aspects of the present disclosure. A brief discussion of how the SOUNDWIRE NEXT payload works is provided with reference to FIGS. 5A and 5B to assist in understanding how the payload is used by the present disclosure. A discussion of particular details of the present disclosure begins below with reference to FIG. 6A.

In this regard, FIG. 1 is a block diagram of an audio system 100 having a multi-drop differential audio bus 102. In particular, the bus 102 couples a master device 104 such as an audio codec or application processor to one or more slave devices 106(1)-106(N). For the purposes of illustration, N is four herein. The slave devices 106(1) and 106(2) may be microphones and include analog-to-digital converters (ADCs) while the slave devices 106(3) and 106(4) may be speakers and include digital-to-analog converters (DACs). The master device 104 includes an interface (sometimes referred to as a downstream facing interface (DFI) in some of the literature) 108, while the slave devices 106(1)-106(N) include respective interfaces (sometimes referred to as upstream facing interfaces (UFIs) in the literature) 110(1)-110(N). While any multi-drop differential audio bus may use aspects of the present disclosure, exemplary aspects specifically contemplate a SOUNDWIRE or SOUNDWIRE NEXT multi-drop differential audio bus.

As better illustrated in FIG. 2, the master device 104 may include the interface 108, which may be a physical layer (PHY) including one or more transistors and/or a bus keeper circuit (not illustrated) that control signal levels on the bus 102. Further, the master device 104 may include a transceiver 112 coupled to the interface 108 and a control system (CS) 114. The transceiver 112 may include a PLL 113 that controls the clock that is used with signals sent from the master device 104. The control system 114 may operate software including drivers or the like and may interoperate with a memory (MEM) 116.

Similarly, a slave device 106 is illustrated in FIG. 3 and may include an interface 110, which may be a PHY including one or more transistors and/or a bus keeper circuit (not illustrated) that control signal levels on the bus 102. Further, the slave device 106 may include a transceiver 118 coupled to the interface 110 and a control system (CS) 120. The transceiver 118 may include a PLL 119 that acts as a clock recovery circuit for the slave device 106. In an exemplary aspect, this PLL 119 is a relatively low-speed circuit as further described below. The control system 120 may operate software including drivers or the like and may interoperate with a memory 122 and control an input/output (I/O) device 124 (e.g., a microphone or speaker). Note that exemplary aspects of the present disclosure also address the situation where the slave has no PLL 119 as better explained below.

In an exemplary aspect, ports on the slave devices 106(1) and 106(2) may act as audio sources in that an audio signal or stream originates therefrom. Likewise, ports on the slave devices 106(3) and 106(4) may act as audio sinks in that audio signals are sent thereto. It should be appreciated that it is possible that the slave devices 106(1)-106(4) may be multi-port devices and thus, could be audio sources and audio sinks. Ports on the master device 104, relative to the slave devices 106(1) and 106(2) may be audio sinks, but may be audio sources relative to the slave devices 106(3) and 106(4). In this regard, the master device 104 may have one or more data ports. That is, a particular port within the master device 104 may be functioning as an audio source or audio sink depending on the nature of the link for the port. It should be appreciated that terms such as audio source and audio sink are frequently used in the industry and refer to, in the case of an audio source, a device from which an audio stream originates. Likewise, an audio sink refers to a device to which an audio stream is sent.

While the audio system 100 of FIG. 1 conforms in appearance to a SOUNDWIRE system, it should be appreciated that exemplary aspects of the present disclosure are applicable to SOUNDWIRE NEXT systems. SOUNDWIRE NEXT was initially referred to as SOUNDWIRE-XL and may be renamed in future iterations. In this regard, FIG. 4 is a block diagram of an exemplary expanded SOUNDWIRE system 400 with a bridge 402 and a SOUNDWIRE NEXT segment 404 formed between an application processor 104 and the bridge 402 by a SOUNDWIRE NEXT cable 406. The SOUNDWIRE NEXT cable 406 is a two-wire cable configured to carry a differential signal thereover. The application processor 104 is a master device relative to the bridge 402. While described as an application processor 104, it should be appreciated that the master device may instead be a codec or other element as is well understood. The application processor 104 may be in a device such as a mobile computing device (not shown) that includes a receptacle 408 configured to receive a SOUNDWIRE NEXT cable such as the SOUNDWIRE NEXT cable 406. The SOUNDWIRE NEXT cable 406 may be up to two meters (2 m or 200 centimeters (cm)) long. The receptacle 408 may be operatively associated with an interface 410 (which may or may not be in the application processor 104) that includes appropriate electrical contacts to convey a differential data signal with an embedded clock signal to the two wires of the SOUNDWIRE NEXT cable 406. The interface 410 may further be operatively coupled to a control system (labeled CS in the Figures) 412. The function of the control system 412 is explored in greater detail below.

With continued reference to FIG. 4, the bridge 402 is configured to operate as a slave device relative to the application processor 104, and translate SOUNDWIRE NEXT signals to SOUNDWIRE signals for use on a SOUNDWIRE audio system 100. In the SOUNDWIRE audio system 100, the bridge 402 acts as a master device and is configured to send and receive signals to slave devices 106(1)-106(N) through a SOUNDWIRE bus 102. While not illustrated, it should be appreciated that another common bridge will link a SOUNDWIRE system to a SOUNDWIRE NEXT system, acting as a slave in the SOUNDWIRE audio system and a master in the SOUNDWIRE NEXT audio system.

Note further, SOUNDWIRE NEXT currently supports a multi-drop arrangement and would look similar to the SOUNDWIRE audio system 100 of FIG. 1. Likewise, the block diagrams of the master device 104 and the slave device 106 of FIGS. 2 and 3 would also generically apply to masters and slaves in a SOUNDWIRE NEXT system.

SOUNDWIRE NEXT defines a conceptual row in a signal stream. This signal stream 500 is illustrated in FIGS. 5A and 5B. Each row 502(1)-502(N) begins with a synchronization event (sometimes referred to as a sync event herein) 504(1)-504(N). Collectively, the synchronization events 504(1)-504(N) form equal timing intervals from which a basic audio clock may be derived. Note that the basic audio clock is different than the frequency of the bus clock. While referred to as a bus clock, it should be appreciated that there is no specific signal that is the bus clock signal. Thus, the bus clock may also be considered a virtual clock or a bus rate in that changes take place on the bus at a rate corresponding to the bus clock. Each period of the bus clock corresponds to a bit slot, which effectively forms columns within the rows 502(1)-502(N). The first column after the synchronization event 504(1)-504(N) is for bus turnaround (TA) shown at 508. After the turnaround 508, the rest of the row 502(1)-502(N) is a payload space 510. While illustrated as rows on top of one another, it should be appreciated that the synchronization event 504(2) of row 502(2) temporally follows a terminal column 512 of the row 502(1) on the bus. As the bus clock 506 increases in frequency, more data may be loaded into the payload space 510 in a given time. However, tracking that very fast data normally requires a high frequency PLL in the slave devices on the bus. Such PLLs are expensive both in cost and space. The expense and cost are particularly unwelcome in simple PDM devices such as microphones and/or simple headsets.

Exemplary aspects of the present disclosure allow the slave devices (and potentially a master) to have a low-frequency PLL that operates at the basic audio clock frequency yet still ascertains appropriate bit slots from which to receive or into which to transmit data. Initially, a few new parameters are defined which are exchanged during initialization of the bus. While particular names are given to these parameters, these names are matters of convenience, and the parameters may be renamed without departing from the present disclosure. These parameters include a sample window interval (sometimes referred to as S herein); a number of samples in a sample window interval (sometimes referred to as N herein); a row offset number (sometimes referred to as R herein); a sample width (sometimes referred to as W herein); a number of channels in a data port (sometimes referred to as C herein); and a horizontal start of window (sometimes referred to as ST herein). Optionally, a port type and a horizontal stop parameter may also be defined.

The sample window interval indicates how many rows are in a given sample. Relative to SOUNDWIRE NEXT, the sample window interval replaces the sample interval. The number of samples in a sample window interval is just that—the number of samples. This value enables groups of multiple samples in an interval. The row offset number indicates within the total number of rows (S) which row has a valid sample. The sample width indicates the number of bits per data sample. The number of channels is just that—the number of channels for the data port. The horizontal start of window indicates how many columns into the row the sample starts relative to the row start. The port type indicates if there are multiple channels inside a row or just one channel per row. The horizontal stop indicates which column is the last of the sample relative to a row beginning.

To assist in understanding the parameters just introduced, FIGS. 6A and 6B illustrate two different signal flows 600 and 650, respectively, with the corresponding values for the parameters as indicated by fields 602 and 652, respectively. Specifically, for the first signal flow 600, S=4; N=1; R=2; W=2; C=1; and ST=12. The signal flow 600 assumes an audio rate of 600 kilohertz (kHz) with a row rate of 2.4 megahertz (MHz) with 32 columns in a row (equivalent to a bus rate of 76.8 MHz) and a single channel (C=1). In this case, the audio rate is relatively slow at 600 kHz. Note that S may be selected in part based on the difference between the audio rate and the audio clock frequency. Four rows make up the sample window interval 604 (S=4). The sample is in row 2 606 (assuming the first row is designated as 0; R=2). The sample is two bits 608(1)-608(2) (W=2). It is a single channel (C=1), so only one sample is present. The sample is offset from the beginning of the row by twelve columns 610 (ST=12). The next sample appears in the same spot in the next sample window interval 612. The slave device 106 may omit a PLL 119 entirely or, if there is a PLL 119 present, the PLL 119 only has to be capable of matching the audio rate of 2.4 MHz and not the bus rate of 76.8 MHz.

In contrast, the signal flow 650 has S=1; N=2; R=0; W=2; C=1; and ST=12. The signal flow 650 assumes a row rate of 2.4 MHz with 32 columns in a row (equivalent to a bus rate of 76.8 MHz) and a single channel (C=1). In this case, the audio rate is 4.8 MHz, which causes the selection of S and N to change to make sure that the throughput remains at the desired levels. Four rows make up the sample window interval 654 (S=4). The sample is in each of the rows 656(1)-656(4) (assuming the first row is designated as 0; R=0). The sample is two bits 658(1)-658(2) (W=2), but N is two, so there are two samples side by side. The sample is offset from the beginning of the row by twelve columns 660 (ST=12). The next sample appears in the same spot in the next sample window interval 662. The slave device 106 may omit the PLL 119, or if the slave device 106 has a PLL 119, the PLL 119 only has to be capable of matching the audio rate of 2.4 MHz (with a simple doubler) or 4.8 MHz and not the bus rate of 76.8 MHz.

It should be appreciated that the signal flows 600 and 650 are provided as examples and show the flexibility and versatility of the present disclosure. Changing the value of S effectively changes the frequency, while changing the value of C, N, or W changes how much data is being sent. Changing the values of R and ST allows data to be positioned as desired within the sample interval window.

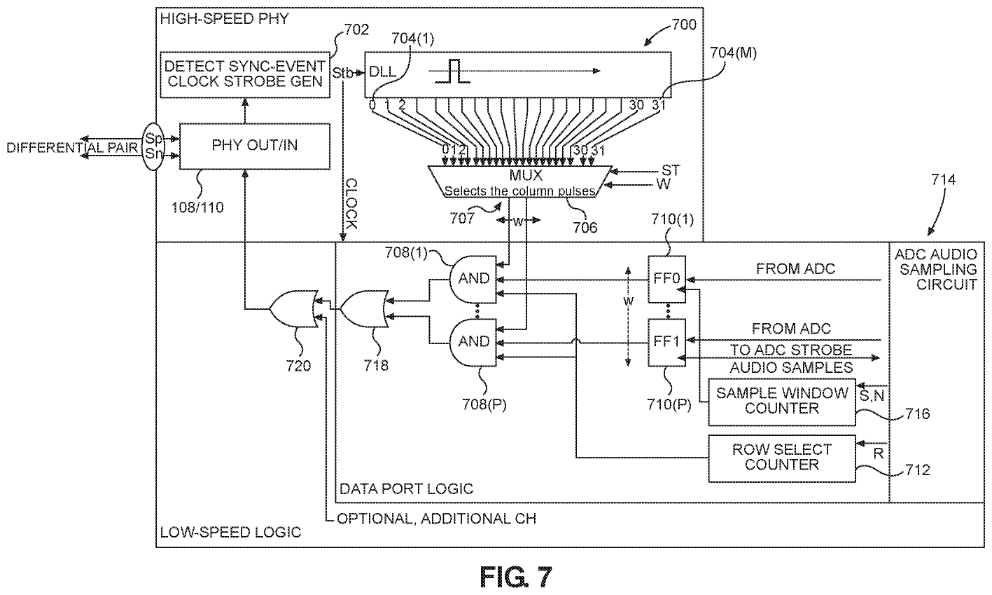

To be able to find the appropriate bit slots or columns into which to place transmitted data or from which to extract received data, exemplary aspects of the present disclosure add a DLL circuit 700, illustrated in FIG. 7, to the transceivers of the respective devices (e.g., the slave device 106). In particular, a detection and strobe generation circuit 702 detects the sync event at the interface 110. A simple strobe generation circuit creates a replicate (e.g., buffered) version of the synchronization event that masks other elements in the signal. The detection and strobe generation circuit 702 pulses or strobes (Stb) the DLL circuit 700, which includes sufficient delay elements (not shown) to match the highest expected number of bit slots in a row and this is reflected by the number of columns.

Each delay element within the DLL circuit 700 includes a respective output tap 704(1)-704(M). The output taps 704(1)-704(M) are provided to a multiplexer (MUX) 706 that selects an appropriate column pulse based on inputs ST and W received through an offset input and a sample width input. The output 707 of the multiplexer 706 is provided to a number of AND gates 708(1)-708(P), where P is equal to the highest expected W. The AND gates 708(1)-708(P) also receive inputs from respective flip-flops 710(1)-710(P). The AND gates 708(1)-708(P) also receive inputs from a row select counter circuit 712 that indicates which row is to be selected based on input R. The flip-flops 710(1)-710(P) receive input from an analog-to-digital sampling circuit 714 and a sample window counter circuit 716 which operates based on S and N. The output of the AND gates 708(1)-708(P) is provided to an OR gate 718 which in turn provides an output to a second OR gate 720. The second OR gate 720 also receives an input based on any possible additional channels (which would have their own set of AND gates and the like). The second OR gate 720 indicates to the interface 110 from which bit slots to extract data or into which bit slots to place data. Note that the interface 110 may not know the precise bit slot, but has an offset relative to the sync event of the appropriate row and uses the data at that spot in the row.

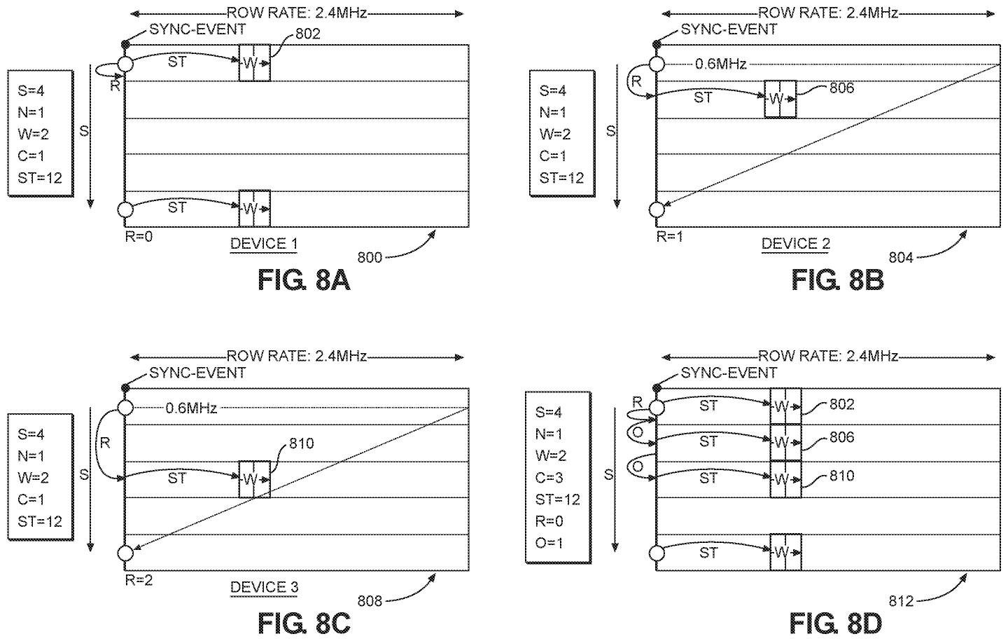

Note that aspects of the present disclosure can be used for multi-channel aggregation by one device (typically a master) as well. Thus, a master, for example, may receive multiple individual channel streams, each one coming from a single device, but together forming a multi-channel stream. An example of such is illustrated in FIGS. 8A-8D, where the different slave devices may put data in respective rows at a designated offset and the master may aggregate the multiple channels. Thus, a first device 800 puts data 802 in a first row in the sample window interval; a second device 804 puts data 806 in a second row in the sample window interval; and a third device 808 puts data 810 in a third row in the sample window interval. A master 812 is equipped with a high-speed PLL that operates at the bus frequency and is able to extract the data 802, 806, and 810 to assemble the multi-channel information. Note that the aggregation need not specifically be done by the master 812. Rather a slave codec or other device that has a high-speed PLL may perform the aggregation. It should be appreciated that the aggregation may begin at the audio source and the slaves extract the appropriate information based on the instructions and parameters provided. This assumes that the type of port is a multi-channel offset between rows.

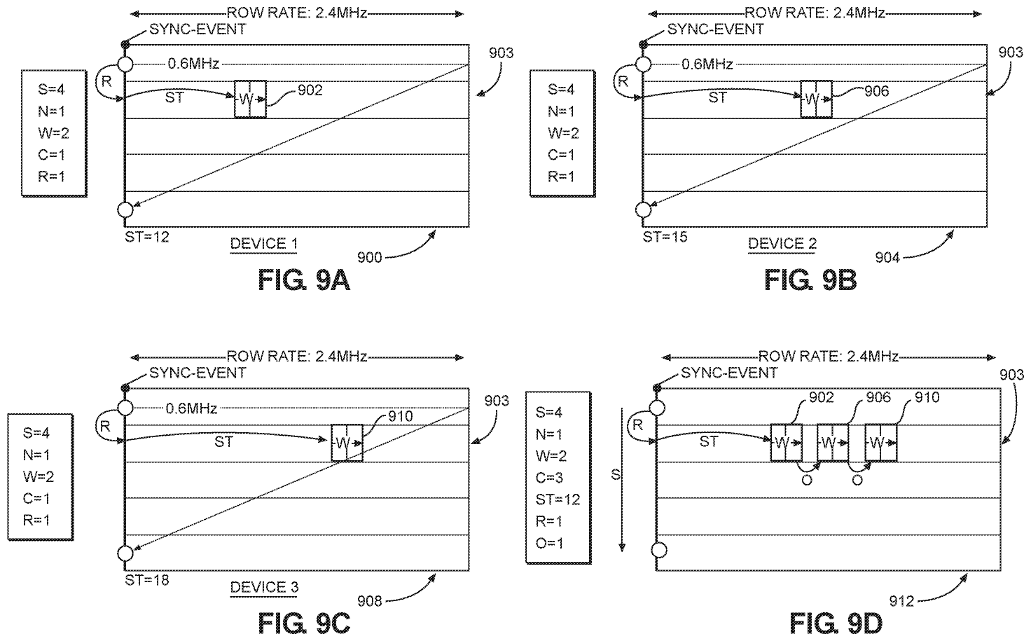

In contrast, FIGS. 9A-9D illustrate a situation where there is a multi-channel offset inside a single row. Thus, a first device 900 puts data 902 in a first row 903 in the sample window interval; a second device 904 puts data 906 in the first row 903 with a different offset; and a third device 908 puts data 910 in the first row 903 with still another offset. A master 912 is equipped with a high-speed PLL that operates at the bus frequency and is able to extract the data 902, 906, and 910 to assemble the multi-channel information. Note that the aggregation need not specifically be done by the master 912. Rather a slave codec or other device that has a high-speed PLL may perform the aggregation. It should be appreciated that the aggregation may begin at the audio source and the slaves extract the appropriate information based on the instructions and parameters provided. This assumes that the type of port is a multi-channel offset all within a single row. The difference between same row and different row may be designated by the port type parameter.

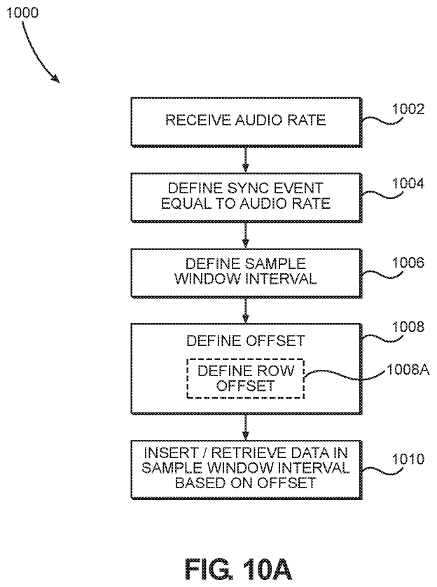

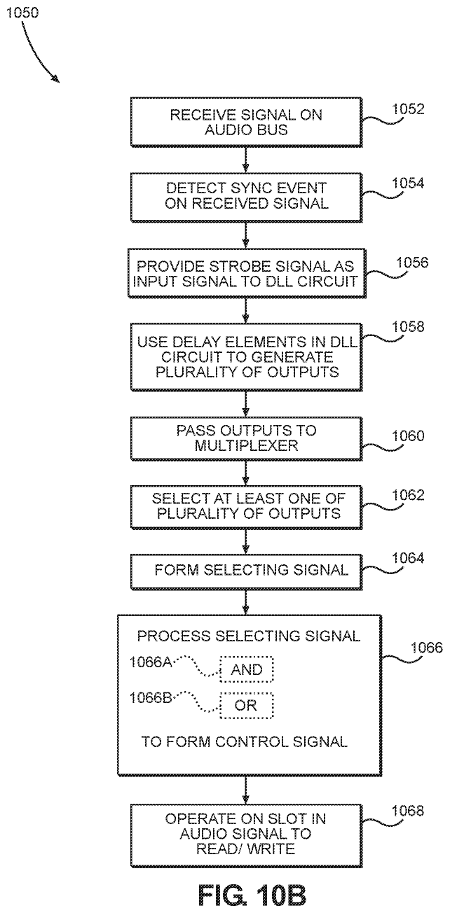

A process 1000 according to an exemplary aspect of the present disclosure is illustrated with reference to FIG. 10A. The process 1000 begins on receipt of an audio rate (block 1002) such as during initialization of an audio bus. The master device 104 may define a sync event to be equal to the audio rate (block 1004). This sync event will be the row sync event. The master device 104 then defines the sample window interval (S) (block 1006), which may be based at least in part on the sync event. Likewise, N may be defined. S and N may be defined according to the following algorithm:
TmpRatio=Sync-Rate/Sample-Rate
If TmpRatio>1 then: S=TmpRatio, and N=1
Else: S=1 and N=1/TmpRatio

The master device 104 then defines the offset (block 1008), which may include a row offset (R) (block 1008A) as well as a start of row offset (ST). Width may likewise be set to indicate a channel width as well as C to define the number of channels. The master devices 104 and slave devices 106 then insert data and retrieve data in the sample window interval based on the offset (block 1010).

An exemplary process 1050 associated with use of the DLL circuit 700 is provided with reference to FIG. 10B. The process 1050 begins when the slave device 106 receives a signal on the audio bus 102 (block 1052). The interface 108 or 110 is monitored by the detection and strobe generation circuit 702 which detects a synchronization event on the received signal (block 1054). The detection and strobe generation circuit 702 provides a strobe signal (Stb) as an input signal to the DLL circuit 700 (block 1056). The DLL circuit 700 uses delay elements in the DLL circuit 700 to generate a plurality of outputs (block 1058). These outputs are passed to the multiplexer 706 (block 1060), which selects at least one of the plurality of outputs (block 1062) based on offset and sample width inputs ST and W, respectively. The multiplexer 706 forms a selecting signal of the various outputs (block 1064). The selecting signal is then processed such as by the AND gates 708(1)-708(P) (block 1066A) and the OR gates 718, 720 (block 1066B) to form a control signal (block 1066). The control signal operates on a slot in the audio signal to read from or write thereinto (block 1068).

The systems and methods for payload transport on audio buses for simple PDM devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

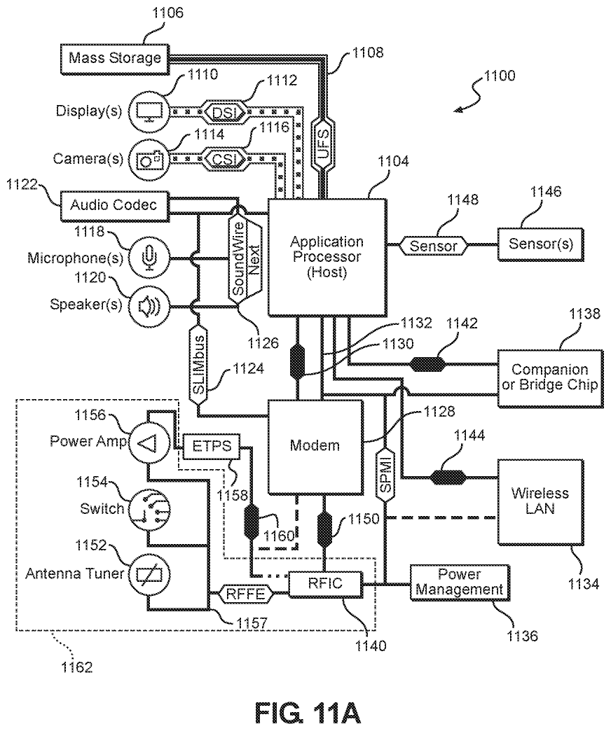

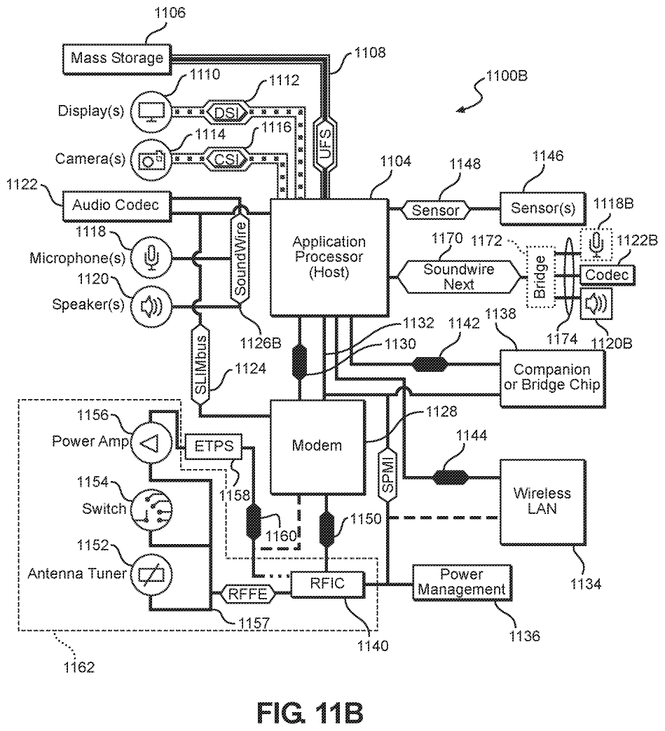

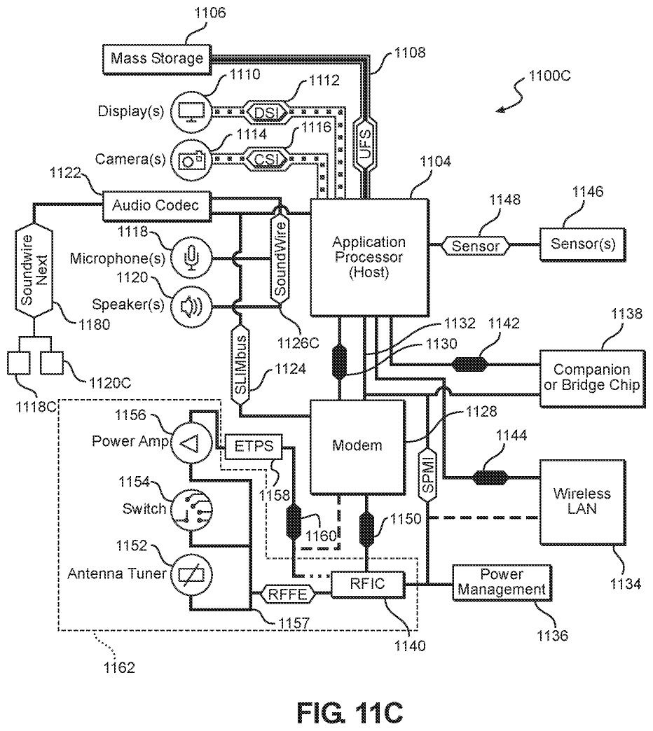

Exemplary aspects of the present disclosure are well suited for use with a SOUNDWIRE NEXT bus. There are a variety of locations in a computing device at which a SOUNDWIRE NEXT bus may be placed. In this regard, FIGS. 11A-11C illustrate various placements. In most instances, the overall architecture is the same. In this regard, FIG. 11A is system-level block diagram of an exemplary mobile terminal 1100 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a multi-drop differential bus. For the sake of illustration, it is assumed that a SOUNDWIRE NEXT bus 1126, which may be the bus 102, within the mobile terminal 1100 is among multiple communication buses configured to use the systems and methods for payload transport according to the present disclosure.

With continued reference to FIG. 11A, the mobile terminal 1100 includes an application processor 1104 (sometimes referred to as a host) that communicates with a mass storage element 1106 through a universal flash storage (UFS) bus 1108. The application processor 1104 may further be connected to a display 1110 through a display serial interface (DSI) bus 1112 and a camera 1114 through a camera serial interface (CSI) bus 1116. Various audio elements such as a microphone 1118, a speaker 1120, and an audio codec 1122 may be coupled to the application processor 1104 through a serial low power interchip multimedia bus (SLIMbus) 1124. Additionally, the audio elements may communicate with each other and the audio codec 1122 through the SOUNDWIRE NEXT bus 1126. A modem 1128 may also be coupled to the SLIMbus 1124. The modem 1128 may further be connected to the application processor 1104 through a peripheral component interconnect (PCI) or PCI express (PCIe) bus 1130 and/or a system power management interface (SPMI) bus 1132. Note that the SLIMbus 1124 may be replaced by a SOUNDWIRE bus in some implementations.

With continued reference to FIG. 11A, the SPMI bus 1132 may also be coupled to a wireless local area network (WLAN) integrated circuit (IC) (WLAN IC) 1134, a power management integrated circuit (PMIC) 1136, a companion integrated circuit (sometimes referred to as a bridge chip) 1138, and a radio frequency integrated circuit (RFIC) 1140. It should be appreciated that separate PCI buses 1142 and 1144 may also couple the application processor 1104 to the companion integrated circuit 1138 and the WLAN IC 1134. The application processor 1104 may further be connected to sensors 1146 through a sensor bus 1148. The modem 1128 and the RFIC 1140 may communicate using a bus 1150.

With continued reference to FIG. 11A, the RFIC 1140 may couple to one or more radio frequency front end (RFFE) elements, such as an antenna tuner 1152, a switch 1154, and a power amplifier 1156 through an RFFE bus 1157. Additionally, the RFIC 1140 may couple to an envelope tracking power supply (ETPS) 1158 through a bus 1160, and the ETPS 1158 may communicate with the power amplifier 1156. Collectively, the RFFE elements, including the RFIC 1140, may be considered an RFFE system 1162.

FIG. 11B illustrates an alternate placement of the SOUNDWIRE NEXT bus. While the majority of the elements are the same as the mobile terminal 1100, the mobile terminal 1100B illustrated in FIG. 11B has a SOUNDWIRE bus 1126B coupling the audio codec 1122 to the microphone(s) 1118 and the speaker(s) 1120. The application processor 1104 may be coupled to a SOUNDWIRE NEXT bus 1170 that may couple to an optional bridge 1172. If the bridge 1172 is present, then the bus 1174 may be a SOUNDWIRE bus. If the bridge 1172 is not present, then the SOUNDWIRE NEXT bus 1170 may couple directly to microphones 1118B, speakers 1120B, and/or an audio codec 1122B.

Similarly, FIG. 11C illustrates another alternate placement of the SOUNDWIRE NEXT bus. In the mobile terminal 1100C, the audio codec 1122 may couple to a SOUNDWIRE bus 1126C and a SOUNDWIRE NEXT bus 1180. The SOUNDWIRE NEXT bus 1180 may couple to microphones 1118C and speakers 1120C.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method of reading data from an audio bus, the method comprising:
using a delay-locked loop (DLL) circuit on an input signal;
selecting, with a multiplexer, at least one of a plurality of outputs from the DLL circuit to form at least one selecting signal;
processing the at least one selecting signal to form a control signal; and
operating on a slot in an audio signal on the audio bus based on the control signal.

2. The method of claim 1, wherein the input signal comprises a strobe signal.

3. The method of claim 2, further comprising generating the strobe signal responsive to detecting a synchronization event on the audio bus.

4. The method of claim 1, further comprising providing the plurality of outputs from the DLL circuit to the multiplexer.

5. The method of claim 4, wherein providing the plurality of outputs comprises generating each of the plurality of outputs with a respective delay element in the DLL circuit.

6. The method of claim 1, further comprising selecting the at least one of the plurality of outputs based on an offset and a sample width parameter.

7. The method of claim 1, wherein processing comprises using an AND gate to AND an audio sample and a signal from a row select counter.

8. The method of claim 7, wherein processing further comprises using an OR gate after using the AND gate.

9. The method of claim 1, wherein operating comprises reading a data slot in the audio signal.

10. The method of claim 9, further comprising passing data read from the data slot to a digital-to-analog converter (DAC).

11. The method of claim 1, wherein operating comprises writing data to a data slot.

12. The method of claim 11, further comprising receiving the data to be written from an analog-to-digital converter (ADC).

13. An audio device comprising:
a bus interface configured to couple to an audio bus operating at a bus frequency;
a clock configured to operate at an audio rate slower than the bus frequency;
a transceiver coupled to the bus interface configured to send and receive data on the audio bus; and
a circuit comprising a delay-locked loop (DLL) and a multiplexer, the circuit configured to:
use the DLL on an input signal from the audio bus;
select with the multiplexer, at least one of a plurality of outputs from the DLL to form at least one selecting signal;
process the at least one selecting signal to form a control signal; and
operate on a slot in an audio signal on the audio bus based on the control signal.

14. The audio device of claim 13, wherein the circuit further comprises a strobe generation circuit configured to generate a strobe signal that operates as the input signal.

15. The audio device of claim 14, wherein the strobe generation circuit is configured to detect a synchronization event on the audio bus.

16. The audio device of claim 13, wherein the DLL is coupled to the multiplexer such that the plurality of outputs from the DLL communicate with the multiplexer.

17. The audio device of claim 16, wherein the DLL comprises a plurality of delay elements, each delay element configured to generate a respective one of the plurality of outputs.

18. The audio device of claim 13, wherein the multiplexer comprises an offset input and a sample width input.

19. The audio device of claim 13, wherein the circuit further comprises an AND gate coupled to the multiplexer.

20. The audio device of claim 19, wherein the circuit further comprises an OR gate coupled to an output of the AND gate.

21. The audio device of claim 19, further comprising a microphone.

22. The audio device of claim 21, further comprising a flip-flop connecting the microphone to the AND gate.

23. The audio device of claim 19, further comprising a speaker.

24. The audio device of claim 13 integrated into an integrated circuit (IC).

25. The audio device of claim 13 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
